(19) United States
(12) Patent Application Publication
(10) Pub. No.: US 2015/0350721 A1
(43) Pub. Date: Dec. 3, 2015

(54) PLL Scan Method for HDTV Products

(71) Applicant: LSI Corporation, San Jose, CA (US)

(72) Inventor: Roger A. Fratti, Mohnton, PA (US)

(73) Assignee: LSI Corporation, San Jose, CA (US)

(21) Appl. No.: 14/290,130

(22) Filed: May 29, 2014

(51) Int. Cl. H04N 21/438; H04N 21/422; H04N 21/426; H04N 21/643; H04N 21/45

(52) U.S. Cl. CPC H04N 21/4384; H04N 21/64322; H04N 21/4524; H04N 21/4263; H04N 21/42206; H04N 21/4382

(57) ABSTRACT

A system and method for improved channel scanning in an HDTV device queries a database with location data input by the user, receiving an ordered list of potential channels associated with the selected location. The system may scan only those potential channels on the ordered list, storing successfully decoded channels in memory. The system may further divide the ordered list into groups based on the relative signal strength of potential channels. If a potential channel of the lowest relative signal strength group cannot be successfully decoded, the system may indicate that scanning is complete.

### TECHNICAL FIELD

The present disclosure generally concerns multimedia devices and particularly concerns encoding/decoding, processing, features and applications for high definition television (HDTV) devices and products.

### BACKGROUND

High definition television (HDTV) devices are becoming increasingly more feature-rich as they become more commonplace. Also becoming more commonplace are internet-enabled television receivers, which can bring media and other content into the home at streaming speed through a high-speed broadband Internet connection. HDTV units must first scan for available channels, which may vary with geographical location. The channel scanning procedure generally involves a phase locked loop (PLL), which steps through every possible channel, seeking and decoding channel signals and storing acquired channels to memory. As most HDTV units are capable of receiving in excess of one hundred channels, the scanning process can be time-consuming and wasteful, due to the need to scan for nonexistent channels. It may therefore be desirable for HDTV channel scanning to improve upon the conventional brute-force approach, scanning only likely channels and providing a shorter, faster autoscan procedure.

### SUMMARY

Embodiments of the invention concern a system and method for improved PLL channel scanning for HDTV devices. In embodiments, a user may input data corresponding to the location of the user or HDTV device. In embodiments, the HDTV device may receive a list of potential channels associated with the location data via querying a dataset, the list ordered based on relative signal strength or another criterion. In embodiments, the HDTV device may then designate the first potential channel as an active channel. In embodiments, the HDTV device may then attempt to decode the active channel. In embodiments, when the active channel is successfully decoded, the HDTV device may then add the active channel to memory and store any associated channel information. In embodiments, the HDTV device may then delete the potential channel from the list and designate the next potential channel on the list as the active channel. In embodiments, the HDTV device may then continue by attempting to decode the new active channel. In some embodiments, the HDTV device may divide the list of potential channels into groups of channels with strong, moderate, and minimal signal strengths respectively. In embodiments, when an active channel is not successfully decoded and the associated potential channel is in a group of potential channels having minimal signal strength, the HDTV device may halt the scanning algorithm, indicate that scanning is complete, and delete all remaining potential channels.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The advantages of the invention may be better understood by those skilled in the art by reference to the accompanying figures in which:

FIG. 1 is a diagram illustrating potential channels received according to an embodiment of the invention;

FIG. 2 is a block diagram of a system according to an embodiment of the invention; and

FIGS. 3 and 4 are process flow diagrams illustrating methods according to an embodiment of the invention.

### DETAILED DESCRIPTION

Features of the present invention in its various embodiments are exemplified by the following descriptions with reference to the accompanying drawings, which describe the present invention with further detail. These drawings depict only selected embodiments of the present invention, and should not be considered to limit its scope in any way.

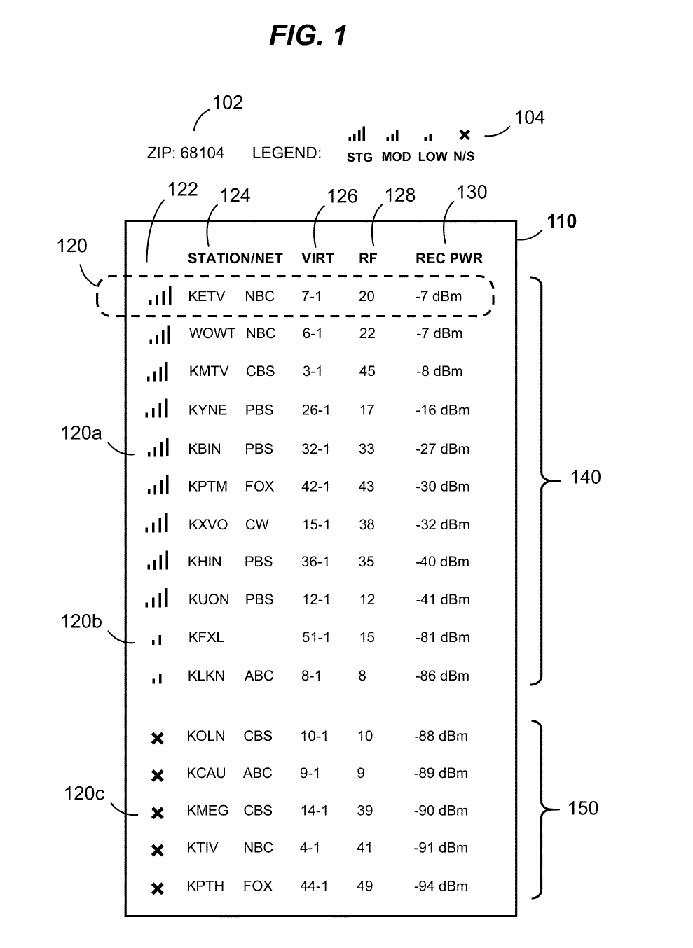

FIG. 1 illustrates information 110 about potential channels available at a given location. A conventional autoscan algorithm employed by the setup mode of a high-definition television (HDTV) device may incorporate a phase-locked loop (PLL) that increments through all available channels attempting to decode a channel signal. Due to the small number of decodable channels available in any given community (usually no more than a dozen), an autoscan algorithm that cycles through every possible channel is likely to waste significant time scanning for nonexistent channels.

In embodiments, an HDTV system according to the present invention may query for potential channel information 110 by submitting location data 102 to a database. In embodiments, location data 102 may be a city and state, a street address, or a ZIP code. The query may return a list no of potential channels 120 available at a location based on a variety of factors: local terrain and forestation, weather and atmospheric conditions, distance from broadcast towers, and the precise equipment used at either end of an HDTV transmission. A potential channel 120 may represent a digital terrestrial television channel or HDTV channel that a user's HDTV device (ex.—receiver) may or may not be able to receive. In embodiments potential channel information 110 may include, for each potential channel 120: relative signal strength 122; a station identity, call letters, or network affiliation 124; a virtual channel 126; an RF channel 128; or signal power 130. In embodiments, a list no of potential channels 120 may be ordered according to relative signal strength 122, with potential channels 120a of high signal strength preceding potential channels 120b of moderate signal strength and potential channels 120C of minimal or no signal strength.

In embodiments, the set no of potential channels may further be divided into a first group 140 and a second group 150 based on relative signal strength 122 or other similar criteria. First group 140 may include those potential channels 120a, 120b having strong or moderate relative signal strength, while second group 150 may include those potential channels 120C having minimal or no relative signal strength.

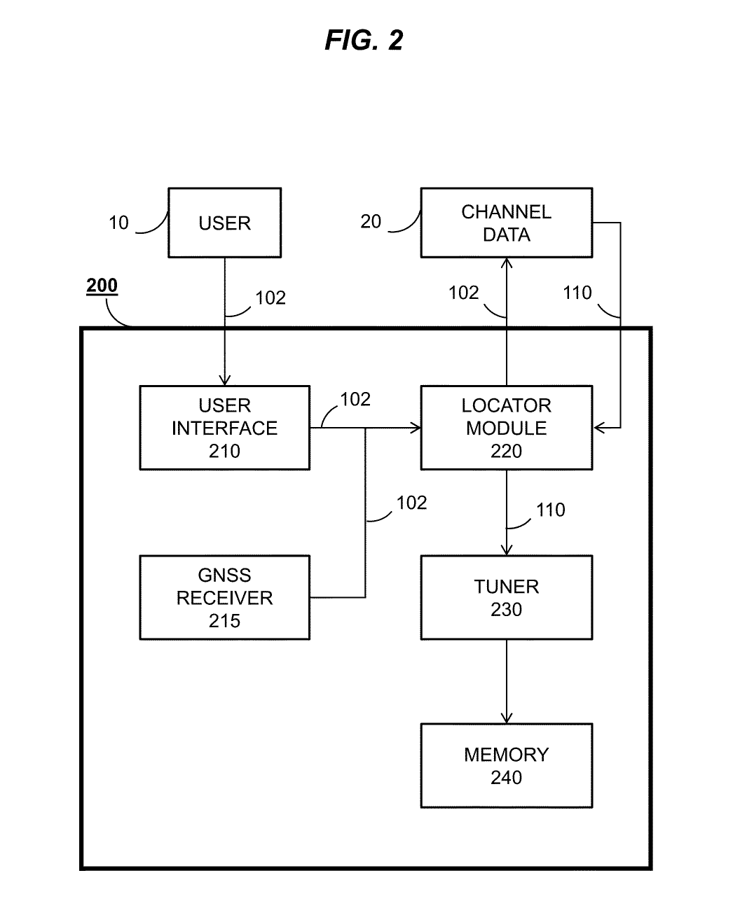

FIG. 2 illustrates the components of an improved PLL scanning system 200 for HDTV devices. In embodiments, a user 10 may input location data 102 through a user interface 210. In embodiments, user interface 210 may include a remote control device that allows the user 10 to enter location data 102 through an onscreen menu of the HDTV device. In some embodiments, the user 10 may access location data 102 via a GNSS receiver 215 (ex.—GPS, GLONASS, Galileo, etc.) configured to submit location data 102 depending on the current location of the HDTV device. In embodiments, a user 10 may utilize the improved channel scanning method by selecting an auto-scan option while in a setup mode of the HDTV device. In some embodiments, the auto-scan option may engage automatically when the HDTV device is placed in setup mode.

In embodiments, location data 102 may be provided to the locator module 220. In embodiments, locator module 220 may query available datasets 20 (ex.—FCC digital reception maps) based on the provided location data 102 to obtain a set 110 of potential channels. In embodiments, tuner 230 may include a phase locked loop (PLL) circuit for channel scanning. In embodiments, rather than employ a brute-force scan through every possible division setting corresponding to a channel, tuner 230 may direct the PLL to scan for only those channels corresponding to the set no of potential channels. In embodiments, tuner 230 may designate the potential channel 120 of highest relative signal strength as an active channel and then attempt to decode the active channel. For example, in embodiments the tuner 230 may calculate an N-value (ex.—integer value, integer divisor) corresponding to the active channel 120 and calibrate the PLL with the N-value. In embodiments, the tuner 230 may then attempt to decode the channel signal associated with the N-value. In embodiments, if a channel signal is decoded, the tuner 230 may then save the active channel and store any associated channel information (ex.—PSIP data, digital subchannels) to memory 240. In embodiments, the tuner may then delete the active channel 120, designate the next potential channel 120 as the active channel, and increment the N-value accordingly.

In some embodiments, if the tuner 230 is unable to decode the channel signal associated with an N-value, and the current active channel is one of a group 150 of potential channels 120 with minimal or no signal strength, the tuner 230 may exit the autoscan process by deleting any remaining potential channels 120 and indicating that scanning has completed.

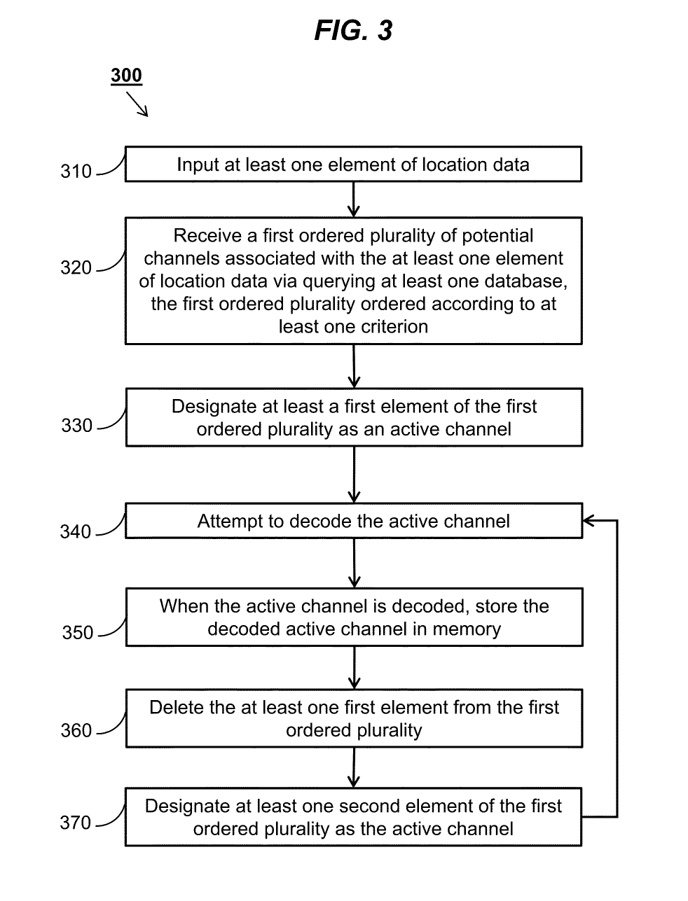

FIG. 3 illustrates a process flow diagram of a method 300 for improved PLL channel scanning in an HDTV device. It is noted herein that the method 300 may be carried out utilizing any of the embodiments described previously. It is further noted, however, that method 300 is not limited to the components or configurations described previously as multiple components and/or configurations may be suitable for executing method 300. At step 310, the method 300 inputs at least one element of location data 102. In embodiments, location data 102 may include a city and state, a street address, or a zip code. In some embodiments, location data 102 may be determined by a GNSS receiver 215. In some embodiments, a user 10 may input location data 102 via a remote control device. At step 320, the method 300 receives a first ordered plurality 110 of potential channels 120 associated with the at least one element of location data 102 via querying at least one database 20, the first ordered plurality no ordered according to at least one criterion. In embodiments, a potential channel 120 may include a relative signal strength 122, a station/network ID 124, a virtual channel 126, an RF channel 128, and a signal power level 130. At step 330, the method 300 designates at least one first element 120 of the first ordered plurality 110 as an active channel. At step 340, the method 300 attempts to decode the active channel. In embodiments, decoding the active channel may include decoding the carrier signal associated with the active channel. At step 350, when the active channel is decoded, the method 300 stores the active channel in memory 240. In embodiments, a stored channel may include at least one of a digital subchannel, channel information, and PSIP data. At step 360, the method 300 deletes the at least one first element 120 from the first ordered plurality 110. At step 370, the method 300 designates at least one second element 120 of the first ordered plurality 110 as the active channel. In embodiments, the method 300 may continue by attempting to decode the new active channel.

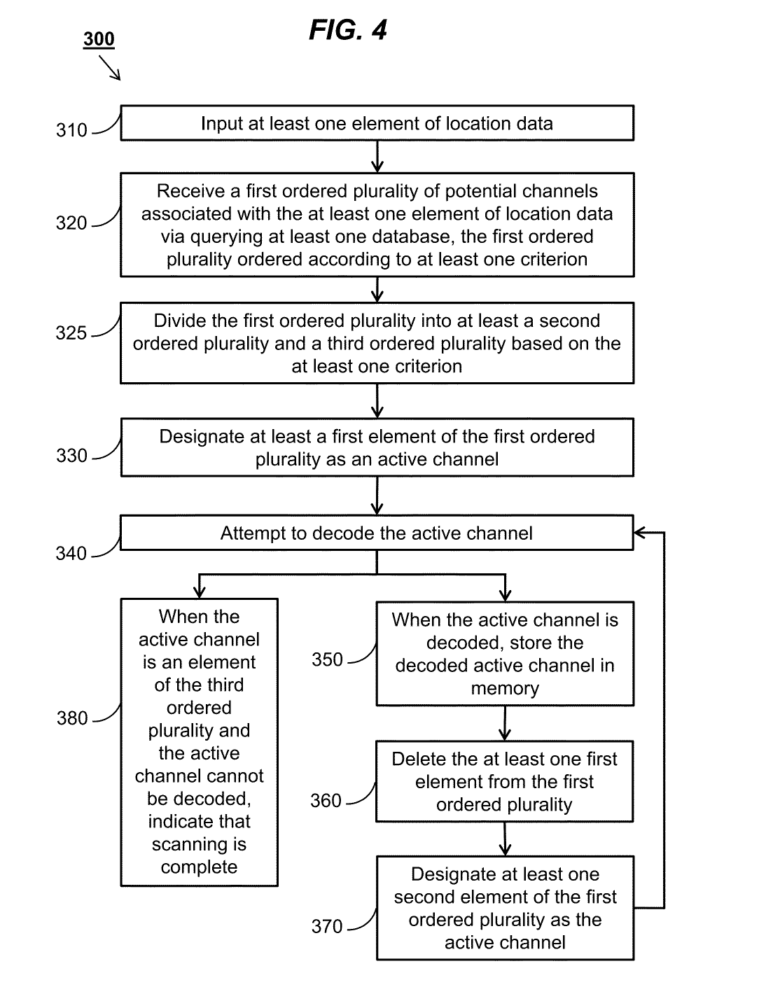

Referring to FIG. 4, method 300 may have additional steps 325 and 380. At step 325, the method 300 divides the first ordered plurality 110 into at least a second ordered plurality 140 and a third ordered plurality 1₅0 based on the at least one criterion. In embodiments, the criterion may include relative signal strength. In embodiments, the set 110 of potential channels 120 may be divided into a set 140 of strong or moderate strength potential channels 120a, 120b and a set 150 of minimal strength potential channels 120C. At step 380, when the active channel is an element of the third ordered plurality 150 and the active channel cannot be decoded, the method 300 indicates that scanning is complete. In embodiments, when a low or minimal strength potential channel 120C cannot be decoded, the scanning algorithm may indicate completion. In embodiments, indicating completion may further include deleting all remaining elements of the first ordered plurality.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

I claim:

1. A method of scanning for HDTV television channels with a tuner, comprising:
inputting at least one element of location data;
receiving a first ordered plurality of potential channels associated with the at least one element of location data via querying at least one database, the first ordered plurality ordered according to at least one criterion;
designating at least one first element of the first ordered plurality as an active channel;
attempting to decode the active channel;
when the active channel is decoded, storing the decoded active channel in memory;
deleting the at least one first element from the first ordered plurality, and
designating at least a second element of the first ordered plurality as the active channel.

2. The method of claim 1, wherein the inputting at least one element of location data includes
inputting at least one element of a city and state, a street address, and a ZIP code.

3. The method of claim 1, wherein a potential channel includes at least one of a relative signal strength, an RF channel associated with the potential channel, and a signal power level.

4. The method of claim 1, wherein the at least one criterion includes signal power level.

5. The method of claim 1, further comprising:
dividing the first ordered plurality into at least a second ordered plurality and a third ordered plurality based on the at least one criterion; and
when the active channel is an element of the third ordered plurality and the active channel cannot be decoded, indicating that scanning is complete.

6. The method of claim 5, wherein each potential channel of the second ordered plurality has a higher signal power than every potential channel of the third ordered plurality.

7. The method of claim 5, wherein the indicating that scanning is complete includes deleting every remaining element of the first ordered plurality.

8. The method of claim 1, wherein the at least one element of location data is determined by a GNSS receiver.

9. A channel scanning system for an HDTV device, comprising:
at least one user interface configured to receive at least one element of location data;
at least one locator module including an internet connection, the locator module communicatively connected to the user interface and configured to query at least one database for at least one potential channel associated with the at least one element of location data via the internet connection; and
receive a first ordered plurality of potential channels associated with the at least one element of location data, the first ordered plurality ordered according to at least one criterion;
at least one tuner communicatively connected to the locator module and configured to
designate at least one first element of the first ordered plurality as an active channel;
attempt to decode the active channel;
store at least one decoded active channel in memory;
delete the at least one first element of the first ordered plurality; and
designate at least one second element of the first ordered plurality as the active channel.

10. The system of claim 9, wherein the at least one tuner is configured to divide the first ordered plurality into at least a second ordered plurality and a third ordered plurality based on the at least one criterion; and
when the active channel is an element of the third ordered plurality and the active channel cannot be decoded, indicating that scanning is complete.

11. The system of claim 10, wherein each potential channel of the second ordered plurality has a higher signal power than every potential channel of the third ordered plurality.

12. The system of claim 10, wherein the at least one tuner is further configured to delete every remaining element of the first ordered plurality.

13. The system of claim 9, further comprising:
at least one GNSS receiver communicatively connected to the locator module and configured to determine the at least one element of location data.

14. The system of claim 9, wherein the at least one user interface is configured to receive at least one element of location data input via a remote controller.

15. An HDTV device including a channel scanning system, comprising:
at least one user interface configured to receive at least one element of location data;
at least one locator module including an internet connection, the locator module communicatively connected to the user interface and configured to query at least one database for at least one potential channel associated with the at least one element of location data via the internet connection; and
receive a first ordered plurality of potential channels associated with the at least one element of location data, the first ordered plurality ordered according to at least one criterion; and
at least one tuner communicatively connected to the locator module and configured to
designate at least one element of the first ordered plurality as an active channel;
attempt to decode the active channel;
store at least one decoded active channel in memory;
delete the at least one first element of the first ordered plurality; and
designate at least one second element of the first ordered plurality as the active channel.

16. The device of claim 15, wherein the at least one tuner is further configured to divide the first ordered plurality into at least a second ordered plurality and a third ordered plurality based on the at least one criterion; and
when the active channel is an element of the third ordered plurality and the active channel cannot be decoded, deleting all remaining elements of the first ordered plurality and indicating that scanning is complete.

17. The device of claim 16, wherein each potential channel of the second ordered plurality has a higher signal power than every potential channel of the third ordered plurality.

18. The device of claim 16, wherein the at least one tuner is further configured to delete every remaining element of the first ordered plurality.

19. The device of claim 15, further comprising:
at least one GNSS receiver communicatively coupled to the locator module and configured to generate the at least one element of location data based on the current location of the device.

20. The device of claim 15, wherein the at least one user interface includes a remote controller.
